(19) United States
(12) Patent Application Publication
(10) Pub. No.: US 2021/0388801 A1
(43) Pub. Date: Dec. 16, 2021

(54) MONOLITHIC FUEL DELIVERY SYSTEM

(71) Applicant: LISI AUTOMOTIVE HI-VOL INC., Livonia, MI (US)

(72) Inventor: Paul G. Carey, Plymouth, MI (US)

(21) Appl. No.: 16/897,880

(22) Filed: Jun. 10, 2020

(51) Int. Cl. F02M 55/02; F02M 55/00; B33Y 80/00; B33Y 10/00; B33Y 50/02; B22F 3/00

(52) U.S. Cl. CPC F02M 55/025; F02M 55/005; B33Y 80/00; B33Y 10/00; F02M 2200/80; B22F 3/008; F02M 2200/857; F02M 2200/856; B33Y 50/02

(57) ABSTRACT

A monolithic fuel delivery system for gasoline direct injection to an engine. The system has a common rail tube body from which injector sockets smoothly and seamlessly extend. Uninterrupted junctions are formed between the rail tube body and the injector sockets. The seamless junctions present a sealed relationship between the tube body and the injector sockets.

### TECHNICAL FIELD

One aspect of this disclosure incudes a monolithic fuel delivery system for gasoline direct injection fuel delivery to an engine.

### BACKGROUND ART

To deliver fuel to direct injection internal combustion engines, a fuel rail or tube is often provided. Frequently, the main fuel is gasoline. Current processes for manufacturing high pressure fuel rails often involve making individual components and tack welding and brazing the components together. This process presents multiple issues related to the strength, accuracy and reliability of the rail assembly. Current methods result in reduction of mechanical strength of the components due to high braze temperatures which cause components to soften. Additionally, high heat causes dimensional distortion of the entire fuel rail assembly. As rail pressures increase, the reliability of the brazed joints can come into question.

Alternative methods of manufacturing may include a forged rail which is then machined. This approach starts with a press forged rail body. Forging lacks any internal features and pathways for fuel. These features need to be secondarily machined. But this results in large amounts of scrap and high cost from the machining operation as well as potentially detrimental burrs within the interior. The forged rail concept also has geometry limitations.

One of the concerns on any welded or brazed joint is the inability to easily verify the reliability of the connection. A brazed joint can visually look satisfactory but be compromised due to variations in the braze process. At higher pressures this would raise concerns about rail safety and performance.

Japanese patent Laid-Open No. 2005-69023 for example discloses a tube or rail along which fuel travels under pressure. Through holes are defined in a wall section of the tube. The fuel rail is formed of diverging branch pipes. As with other prior art disclosures, metal fittings are connected to the tube by a brazing step after the metal fittings are inserted into through holes provided in a peripheral wall section of the main rail.

When the fuel rail and fuel injectors are subjected to high pressures in direct injection gasoline engines, for example, there is sometimes a tendency for fuel to leak, especially if a positional accuracy and roughness sealing surfaces are suboptimal. See, e.g., Japanese patent Laid-Open No. 2003-129920. If the fuel rail is assembled by brazing, there may be adverse consequences to dimensional accuracy and predictability adjacent to a fuel injector holder. If tolerances are exceeded, fuel leakage problem may occur. In some situations, it may be difficult to correct out-of-tolerance circumstances because the wall thickness of the rail is prohibitively thick. Additionally, remedial measures may weaken a seal since the brazing filler metal may accumulate at the junction between a seal ring and the injector holder. Surface roughness of a sealing surface may thereby be caused.

Fuel rails made of aluminum for direct-injection internal combustion engines cannot be used where injection pressures may reach 150-250 MPa. This is because the strength of aluminum is relatively low. Further, the fuel rail may have disadvantageous layout characteristics because the wall thickness of the rail must be sufficient to withstand high fuel pressures. Consequently, production costs rise because contact surfaces with fuel must be treated by expensive surface treatment protocols. This may be required if the aluminum fuel rail is sensitive to alcohol and corrosive fuel.

Among the art considered before filing this patent application are: U.S. Pat. Nos. 8,596,246; 8,844,500; 8,844,502; 8,074,624; EP 2284385; EP 2333302; and commonly owned U.S. Pat. No. 10,208,723.

### SUMMARY

One way to overcome such shortcomings is to use a 3-D metal printing process to manufacture a one-piece fuel delivery system with a fuel rail body from which injector sockets seamlessly extend. Such a system eliminates connections that can leak or fail during use, and results in improved strength. Potential leaks at connection sites are eliminated. Internal burrs and chips associated with conventional internal machining are minimized. This heightens efficiency by improving fluid flow while minimizing related turbulence and back pressure.

The proposed fuel delivery system and its method of manufacture also eliminates any adverse exposure to heat. One consequence is that dimensional variation is minimized. Further, the annealing of components which is detrimental to the overall strength of the rail is avoided. The proposed process creates smooth, seamless internal features during a printing step.

Such an approach to manufacturing minimizes the need for secondary machining and the scrap generated. These factors result in a lower cost product.

One aspect of this disclosure involves gasoline direct injection fuel delivery systems in which a fuel rail and one or more injector sockets are monolithic in the sense that they are unitary. Such a one-piece construction lacks screw threads between injector sockets and a fuel rail body. This unitary fuel delivery system withstands increased pressure and meets performance requirements without leakage between the injector sockets and the fuel rail body. As described further below, one departure from conventional approaches and structures is that there is no longer a need to attach injector sockets to the fuel rail body via a threaded connection and a brazing step.

The resulting monolithic fuel delivery system significantly increases allowable fuel pressure and structural reliability while decreasing fuel rail system complexity.

In one form, the present disclosure relates to a one-piece fuel delivery system including a rail (a delivery pipe) for supplying high pressure fuel from fuel booster pumps. Fuel is injected through seamless passages between the fuel rail body and one or more fuel injector sockets via injection nozzles into an engine cylinder.

One embodiment of a monolithic, one-piece fuel delivery system for gasoline direct injection fuel delivery to an engine includes a common fuel rail tube body with internal and external walls, an upstream end and a downstream end. Injector sockets extend seamlessly from smooth passages between the internal and external walls of the fuel rail body. In some embodiments, the monolithic fuel rail has end threads defined in the internal wall of the tube body at its the upstream and downstream ends. A fuel inlet with threads engages the upstream end threads at the upstream end of the tube. An end cap sensor boss with threads engages the downstream end thread at the downstream end of the tube.

Each of the injector sockets has a proximal nipple end region extending from the rail tube body and a distal end region proximate an engine cylinder to which fuel is delivered under pressure. This arrangement enables the monolithic fuel delivery system to withstand higher maximum pressures than those at which conventional fuel rail assemblies can operate safely.

The disclosed one-piece fuel rail is expected to be used at higher maximum pressures equal to or in excess of approximately 35 MPa (5000 PSI) and will address concerns as to the integrity and reliability of conventional brazed joint connection.

### BRIEF DESCRIPTION OF THE DRAWINGS

FIG. 1 is a quartering perspective view of a monolithic fuel rail according to one embodiment of the invention;

FIG. 2 is a top view thereof;

FIG. 3 is a back side view thereof;

FIG. 3A is a sectional view taken along the line A-A in FIG. 3;

FIG. 4 is an end view of a monolithic fuel rail; and

FIG. 5 is a sectional view taken along the line B-B in FIG. 4.

### DETAILED DESCRIPTION OF THE INVENTION

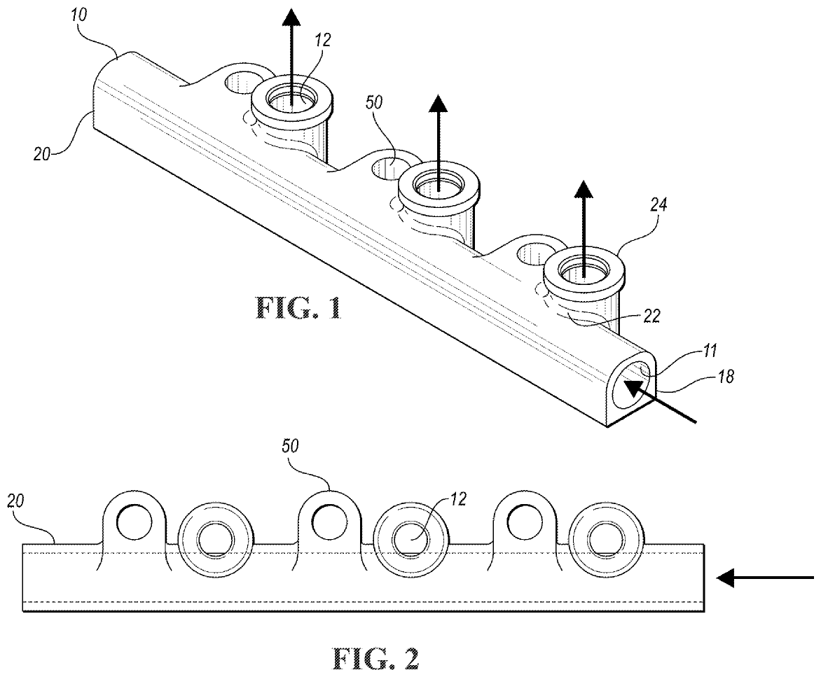

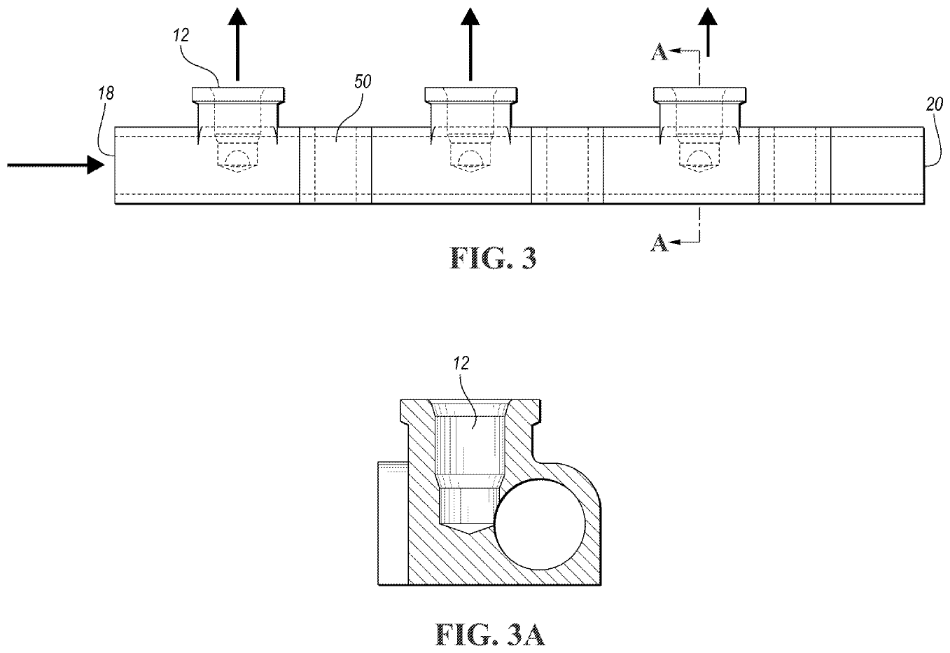

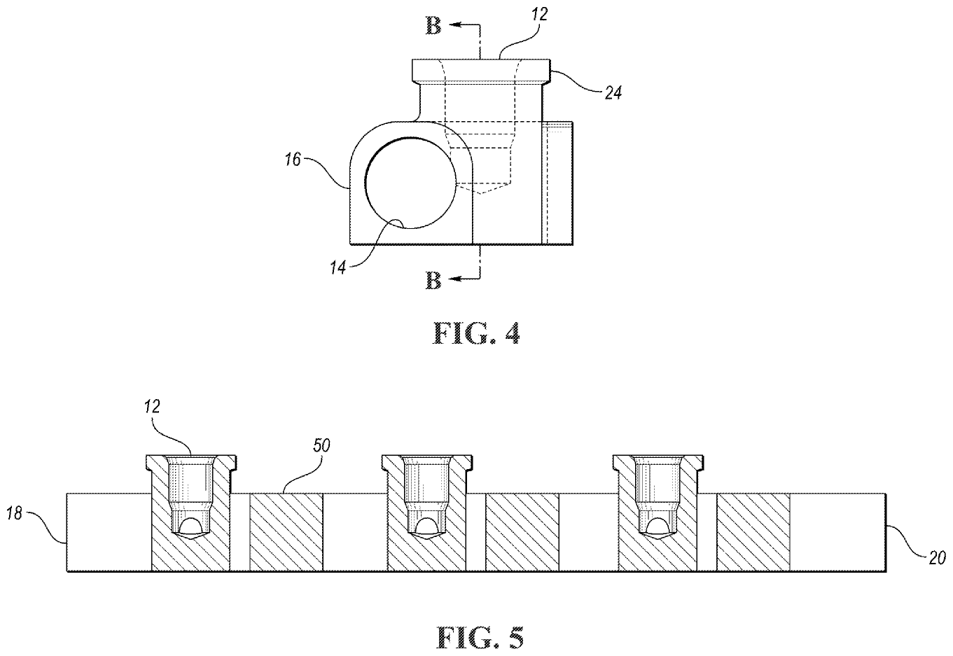

One aspect of this disclosure involves gasoline direct injection fuel delivery systems that are made preferably by 3-D or laser printing and operate under pressures that may be as high as 35 MPa (5000 PSI). One design objective is to provide a monolithic, single piece fuel delivery system with a rail body 10 from which one or more injector sockets 12 extend to withstand increased pressure and performance requirements (FIGS. 1-5).

As described further below, one departure from conventional approaches and structures includes a method of making a one-piece structure that includes unifying the injector sockets 12 and the fuel rail body 10 so that there is no intermediate joint or seam from that may induce turbulent flow or from which fluid under high pressure may leak. A brazing step is no longer used. Injector sockets need no longer to be screwed into the fuel rail body. The disclosed structure and its method of making allow safe and reliable operation under high fuel rail pressures and provide structural reliability while decreasing fuel delivery system complexity.

The Article of Manufacture

In one form, the present disclosure relates to a fuel delivery system including a rail body 10 with integral fuel injector sockets 12 for supplying high-pressure fuel from fuel booster pumps through a tube inlet 11. Fuel is directly injected into engine cylinders 13 through one or more fuel injection nozzles that extend from the injector sockets 12.

One embodiment of a fuel delivery system for gasoline direct injection of fuel to an engine includes a common rail tube body 10 with internal 14 and external 16 walls (FIG. 4), an upstream end 18 and a downstream end 20. The tube 10 has threaded passages only at the upstream and downstream ends. There are no threads, joints or seams that secure the injector sockets to the rail body because the injector sockets extend from the fuel rail body as a one-piece construction (further described below).

One consequence of the disclosed fuel delivery system is that it presents internal fluid conduits that have smooth walls. As a result, fluid flow is relatively unobstructed. Back pressures and flow disturbance that would otherwise be caused by internal wall discontinuities are avoided.

Each of the injector sockets 12 receives an injector that has a proximal end region 22 that forms a junction that seamlessly extends from the tube body 10 and a distal end region 24 which is juxtaposed with an engine cylinder 13. It will be appreciated that the number of injector sockets will vary depending on the number of engine cylinders to which fuel is delivered, e.g., 4 for a 4-cylinder engine and 2×3 for a 6-cylinder engine with 3 sockets on each side of the fuel rail body and 2× for an 8-cylinder engine 4 with 4 sockets on each side of the fuel rail body Similarly, for the number of mounting bosses.

To secure the one-piece fuel delivery system 10 to an engine block 13, one or more mounting bosses 50 seamlessly extend from the rail body 20.

In some embodiments, the fuel rail assembly has end threads defined in the internal wall at the upstream 18 and downstream ends 20 of the tube 10. A fuel inlet with threads engages the upstream end thread at the upstream end 18 of the tube 10. An end cap sensor boss with threads engages the downstream end thread at the downstream end 20 of the tube.

Method of Making

A preferred method of making the disclosed fuel delivery system is by 3-D printing. In one approach to additive manufacturing, a monolithic fuel delivery system is made, preferably by a 3-D metal printing process using a Studio System offered by Desktop Metal of Burlington, Mass. See, www.desktopmetal.com/products/studio, the disclosure of which is incorporated by reference. To create complex metal parts, a typical system includes a printer, a de-binder and a furnace. Each of the three hardware components of the system is controlled by cloud-connected software.

Beginning with a monolithic fuel delivery system design in a native CAD format, the printer builds a green part component by extruding rods of metal powder and a binder (feedstock) through a nozzle and prints layer by layer in precise geometric shapes. The de-binder prepares green parts for sintering by using a fluid solution to remove a wax portion and produce a brown part. The furnace sinter may use a hybrid application of conventional heating and microwave energy to densify the brown part by removing the binder through evaporation, thus fusing metal particles together. If desired, multiple furnaces could be associated with one printer.

To achieve high resolution, tolerances in the fabricated monolithic fuel delivery system are expected to be up to two thousandths of an inch per inch, with densities around 96-99 percent. Materials to be handled by the Studio System may include 17-4 PH Stainless, 316L Stainless, H13 Tool Steel, 4140 Chrome Moly, Inconel 625 Superalloy and Kovar F-15. Other materials are under development for use in serial production in an additive manufacturing environment.

The disclosed additive manufacturing process allows for designs that currently cannot be achieved with a one-piece forged rail approach.

Another possible manufacturing technique is to use laser printing.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A monolithic fuel delivery system for gasoline direct injection to an engine, the system comprising
a common rail tube body with a longitudinal axis, an internal and an external wall, an upstream end and a downstream end, the tube body having
one or more passages extending between the internal and external walls;
one or more injector sockets that are adapted to extend seamlessly from the one or more passages, each injector socket having
a proximal end region extending from the tube body and a distal end region through which fuel is delivered to the engine,
seamless junctions being formed between the tube body and the injector sockets, the seamless junctions presenting a sealed relationship between the tube body and the injector sockets; and
one or more mounting bosses that seamlessly extend from the fuel rail body for securing the fuel delivery system to the engine, wherein the one or more injector sockets and the one or more mounting bosses are aligned.

2. (canceled)

3. The monolithic fuel delivery system of claim 1, wherein the fuel is injected into the engine at pressures up to 5000 psi.

4. The monolithic fuel delivery system of claim 1 made by a 3-D printing process.

5. The monolithic fuel delivery system of claim 1 wherein there are 3 injector sockets.

6. The monolithic fuel delivery system of claim 1 wherein there are 4 injector sockets.

7. The monolithic fuel delivery system of claim 1 wherein there are 6 injector sockets.

8. The monolithic fuel delivery system of claim 1 wherein there are 3 mounting bosses.

9. The monolithic fuel delivery system of claim 1 wherein there are 4 mounting bosses.

10. The monolithic fuel delivery system of claim 1 wherein there are 6 mounting bosses.

11. The monolithic fuel delivery system of claim 1 wherein there are 2 sets of 3 injector sockets for a 6-cylinder engine with 3 sockets on each side of the fuel rail body.

12. The monolithic fuel delivery system of claim 1 wherein there are 2 sets of 4 injector sockets for an 8-cylinder engine with 4 sockets on each side of the fuel rail body.

13. The monolithic fuel delivery system of claim 1 wherein there are 2 sets of 3 mounting bosses for a 6-cylinder engine with 3 mounting bosses on each side of the fuel rail body.

14. The monolithic fuel delivery system of claim 1 wherein there are 2 sets of 4 mounting bosses for an 8-cylinder engine with 4 mounting bosses on each side of the fuel rail body.

15. The monolithic fuel delivery system of claim 1, further comprising end threads defined in the internal wall at the upstream and downstream ends of the tube;
a fuel inlet with threads that engage the upstream end thread at the upstream end of the tube; and
an end cap or pressure sensor boss with threads that engage the downstream end thread at the downstream end of the tube.

16. The monolithic fuel delivery system of claim 1, made by a 3-D printing method.

17. The monolithic fuel delivery system of claim 1, made by a laser printing method.

18. A method of making the monolithic fuel delivery system of claim 1, comprising the steps of:
preparing a CAD drawing of the fuel rail body, injector sockets and mounting bosses extending therefrom, wherein the injector sockets and the mounting bosses are aligned;
communicating design details of the fuel rail, injector sockets and mounting bosses to a 3-D printer;
building a green part component by extruding rods of metal powder and a binder through a nozzle and printing layer by layer;
delivering the green part component to a de-binder that prepares green parts for sintering by using a fluid solution to remove a wax portion and produce a brown part; and
forwarding the brown part to a furnace that uses a hybrid application of conventional heating and microwave energy to densify the brown part by removing the binder through evaporation, thus fusing metal particles together.
